(19) United States
(12) Patent Application Publication
(10) Pub. No.: US 2025/0203451 A1
(43) Pub. Date: Jun. 19, 2025

(54) ADAPTIVE ADJUSTMENTS OF NETWORK SETTINGS FOR HIGH-RELIABILITY WIRELESS NETWORK

(71) Applicant: Cisco Technology, Inc., San Jose, CA (US)

(72) Inventors: Jerome HENRY, Pittsboro, NC (US); Pascal THUBERT, Roquefort Les Pins (FR); Jean-Philippe VASSEUR, Saint Martin D'uriage (FR)

(21) Appl. No.: 18/592,319

(22) Filed: Feb. 29, 2024

Related U.S. Application Data
(60) Provisional application No. 63/609,807, filed on Dec. 13, 2023.

(51) Int. Cl. H04W 28/02; H04L 1/00

(52) U.S. Cl. CPC H04W 28/0289; H04L 1/0003; H04W 28/0268; H04W 28/0284

(57) ABSTRACT

Techniques for adaptively adjusting retry limits and modulation and coding scheme (MCS) thresholds are provided. A first network device receives a traffic flow from a second network device via a wireless network. The first network devices analyzes the traffic flow to identify a network service associated with the traffic flow. The first network device examines one or more predefined network service policies to determine one or more characteristics of the network service. The first network device detects a network congestion within the wireless network. Responsive to detecting the network congestion, the first network device switches to a congestion management mode, which further comprises that the first network device determines one or more network transmission settings for the traffic flow based on the one or more characteristics, and communicates the one or more network transmission settings to the second network device.

### CROSS-REFERENCE TO RELATED APPLICATIONS

This application claims benefit of co-pending U.S. provisional patent application Ser. No. 63/609,807 filed Dec. 13, 2023. The aforementioned related patent application is herein incorporated by reference in its entirety.

### TECHNICAL FIELD

Embodiments presented in this disclosure generally relate to wireless communication. More specifically, the embodiments disclosed herein relate to adaptive adjustments of retry limits and modulation and coding scheme (MCS) thresholds for traffic flows according to their respective quality of service (QoS) requirements.

### BACKGROUND

Wi-Fi 8 primarily focuses on high reliability, which includes the ability to use wider channels and transmit data at higher rates. In addition, Wi-Fi 8 aims to improve the management of network traffic, with the goal of reducing network congestion and ensuring stable performance in high-density environments. In situations where network congestion occurs and channel utilization (CU) increases, conventional methods such as unscheduled, random access to the network may become inefficient. Consequently, scheduled access, where the network determines when each device can transmit data, becomes more desirable. However, even with the scheduling, there may be more data packets than available timeslots for transmission. To address this issue and facilitate more efficient data transfer, access points (APs) may act as schedulers or orchestrators, prioritizing certain access categories (ACs) over others. This approach, however, does not eliminate the congestion as it simply grants temporary advantages for some applications over others, relying on the assumption that these less prioritized applications will adjust their behaviors automatically to alleviate the congestion (e.g., by slowing down data transmissions). The temporal prioritization strategy only offers a short-term solution and does not resolve the congestion issues in the long run.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate typical embodiments and are therefore not to be considered limiting; other equally effective embodiments are contemplated.

FIG. 1 depicts an example environment that supports adaptive adjustments of network transmission settings for different traffic flows, according to some embodiments of the present disclosure.

FIG. 2 depicts an example congestion ratio function that categorizes available traffic flows into two priority classes, according to some embodiments of the present disclosure.

FIG. 3 depicts a sequence by which an access point (or a wireless controller) evaluates and implements network adjustments for optimized traffic flow management, according to some embodiments of the present disclosure.

FIG. 4 depicts an example method for assessing network conditions and assigning corresponding QoS parameters for effective data transmission, according to some embodiments of the present disclosure.

FIG. 5 is a flow diagram depicting an example method for adaptively adjusting network transmission settings based on the QoS requirements of different traffic flows, according to some embodiments of the present disclosure.

FIG. 6 depicts an example computing device configured to perform various aspects of the present disclosure, according to one embodiment.

To facilitate understanding, identical reference numerals have been used, where possible, to designate identical elements that are common to the figures. It is contemplated that elements disclosed in one embodiment may be beneficially used in other embodiments without specific recitation.

### DESCRIPTION OF EXAMPLE EMBODIMENTS

### Overview

One embodiment presented in this disclosure provides a method, including receiving, by a first network device, a traffic flow from a second network device via a wireless network, analyzing, by the first network device, the traffic flow to identify a network service associated with the traffic flow, examining, by the first network device, one or more predefined network service policies to determine one or more characteristics of the network service, detecting, by the first network device, a network congestion within the wireless network, and responsive to detecting the network congestion, switching, by the first network device, to a congestion management mode. The switching to the congestion management mode further comprises determining, by the first network device, one or more network transmission settings for the traffic flow based on the one or more characteristics, and communicating, by the first network device, the one or more network transmission settings to the second network device.

Other embodiments in this disclosure provide one or more non-transitory computer-readable mediums containing, in any combination, computer program code that, when executed by operation of a computer system, performs operations in accordance with one or more of the above methods, as well as systems comprising one or more computer processors and one or more memories collectively containing one or more programs, which, when executed by the one or more computer processors, perform operations in accordance with one or more of the above methods.

### Example Embodiments

The present disclosure provides techniques designed for optimizing network traffic management to ensure high-reliability wireless transmissions, particularly in high-density environments with congestion. To effectively mitigate congestion and ensure stable transmission, in some embodiments of the present disclosure, an access point (AP) (or a wireless controller (WLC)) may determine the specific application or network service (like video conferencing) for each traffic flow managed by an associated client device (or a station (STA)). Based on the identification, the AP (or WLC) may adaptively adjust the transmission settings for the corresponding STA, such as changing retry limits and/or modifying MCS thresholds. By implementing these adjustments, the network can effectively balance the demands of congestion mitigation with the specific QoS requirements of each identified network service, to ensure optimized performance even in high-density environments.

In some embodiments of the present disclosure, the AP (or the WLC) may use methods such as deep packet inspection (DPI) to determine the specific network service (or application) associated with a given traffic flow. This may involve examining the header and/or payload of packets transmitted between the STA and the AP to identify specific network services (or applications) associated with the traffic flow. Upon detecting the associated network services (or applications), in some embodiments, the AP (or the WLC) may check predefined QoS policies to determine the specific transmission requirements or preferences for the traffic flow. The transmission requirements or preferences may relate to aspects such as latency, jitter sensitivity, reliability, and traffic criticality, among other factors. In some embodiments, the STA may indicate the specific QoS requirements for its traffic flow by embedding an access category (AC) label (as defined in Wi-Fi Multimedia (WMM) standards) or a differentiated services code point (DSCP) value (used in IP networking) within its packets. The information may help the AP (or the WLC) to understand the nature of the traffic (e.g., voice, video, best effort, background).

In some embodiments of the present disclosure, based on the identified QoS requirements (e.g., latency, reliability, traffic criticality), the AP (or the WLC) may calculate a priority value for each network service (or application). For example, the AP may assign a higher priority value to network services that require low latency, are sensitive to jitter, and are critical to business operations. As used herein, “traffic criticality” may refer to the importance of a network service or traffic flow in the context of organizational operations and goals. For example, within a corporate setting, network policies may be established to categorize network services (or applications) related to video conferencing as having higher traffic criticality compared to services (or applications) associated with general file downloading, web browsing, or media streamlining. Consequently, traffic flows associated with video conferencing, which require low latency, are sensitive to jitter, and have a higher traffic criticality, may be assigned a higher priority value than traffic flows associated with less critical services. Based on the calculated priority values, the AP (or the WLC) may prioritize traffic flows with different STAs from the lowest to the highest. In some embodiments, instead of or in addition to assigning a priority value for each traffic flow, the AP (or the WLC) may generate a function to categorize traffic flows (or their associated applications) into multiple classes, such as high-priority and low-priority classes, considering factors like jitter sensitivity and traffic criticality.

In some embodiments of the present disclosure, the AP (or the WLC) may adjust the network transmission settings of a STA based on the class of traffic that the STA is currently handling. For STAs handling with high-priority traffic, the AP (or WLC) may instruct them to use higher retry limits and/or a more aggressive strategy for MCS index selection. As used herein, an “aggressive strategy” may refer to an approach that prioritizes the data rate over reliability when selecting MCS indices, favoring faster transmission speeds even at the risk of increased errors. The higher retry limits are designed to counterbalance these potential errors, to ensure high-priority traffic is transmitted both quickly and reliably, even in a congested network environment. For STAs primarily managing low-priority traffic, the AP (or the WLC) may instruct them to use lower retry limits and/or a more conservative MCS index selection strategy. As used herein, a conservative approach prioritizes reliability and signal robustness, opting for MCS indices that offer lower data but are more stable with reduced likelihood of errors. The lower retry limits are configured to speed up the decision to drop the traffic if it fails to transmit successfully the first time. Such a combination ensures a balance between the need to conserve network resources for high-priority traffic and the necessity of ensuring traffic delivery for low-priority traffic. If a STA is handling multiple types of traffic flow simultaneously, the AP may instruct the STA to identify the type/class of traffic (e.g., streaming video, voice over IP (VoIP), web browsing), and apply different MCS index selection strategies, as well as different retry limits for each type/class of traffic.

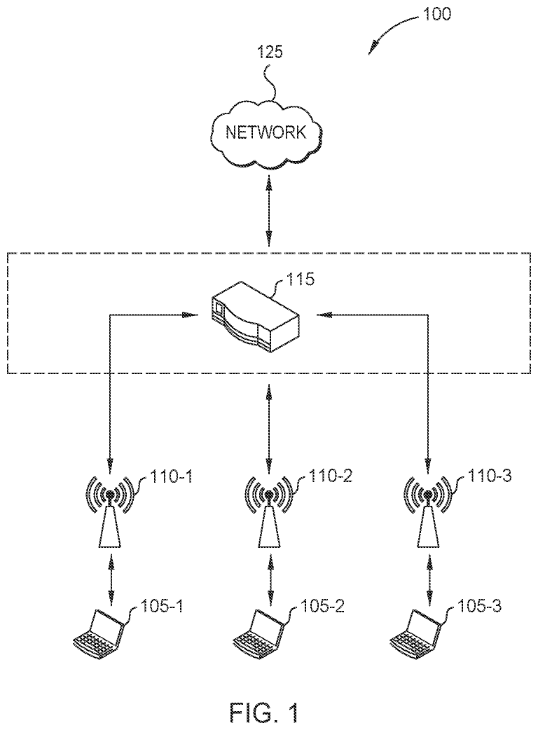

FIG. 1 depicts an example environment 100 that supports adaptive adjustments of network transmission settings for different traffic flows, according to some embodiments of the present disclosure.

The illustrated environment 100 shows a network infrastructure comprising a WLC 115, three APs 110, and three stations (STAs) (or client devices) 105. The WLC 115 serves as the central management unit, connecting to all three APs 110. In this network infrastructure, the WLC 115 may be configured to oversee network operations, manage QoS policies, and coordinate network resources across the three APs 110. Each AP 110 may be associated with one or more STAs within its coverage area, and connect the associated STAs to a broader network. For example, as illustrated, AP 110-1 is associated with STA 105-1, and facilitates downlink and/or uplink data transmission between STA 105-1 and the network 125. Similarly, AP 110-2 is connected to STA 105-2, and AP 110-3 is connected to STA 105-3. The association/connection ensures a stable and efficient communication path.

In the illustrated environment 100, the three APs 110 also connect to the WLC 115, and implement the policies and configurations set by the WLC 115. In some embodiments, STAs 105 may represent a variety of client devices, which include, but are not limited to, laptops, smartphones, tablets, and other Internet-of-thing (IoT) devices, connecting to APs 110 for network access.

In some embodiments, the traffic flow between each STA and its respective AP may be associated with different network services or applications. For example, the data transmitted between STA 105-1 and AP 110-1 may relate to video conferencing or voice over IP (VoIP), which relies on low latency and stable bandwidth for clear video/audio communication. Data exchanged between STA 105-2 and AP 110-2 may relate to cloud-based storage applications, which involve uploading or downloading data (or both), and rely on a balance of bandwidth and latency based on the task. In addition, traffic flows between STA 105-3 and AP 110-3 may be associated with services like online gaming, which relies on low latency for real-time interaction and fast response times. Each of these network services or applications has different transmission requirements that the network must accommodate for optimal performance.

In some embodiments, the transmission settings (e.g., retry limits, MCS index selection) of each STA 105 may be dynamically adjusted based on the type or class of traffic it is currently handling. In some embodiments, the type of traffic or its associated network service (or application) may be determined by examining the header of the packet sent between the STA (e.g., 105-1) and its respective AP (e.g., 110-1). The packet headers may include various attributes, such as the source and destination IP addresses, source and destination port numbers, and the protocol type (e.g., transmission control protocol (TCP), user datagram protocol (UDP)). By analyzing these attributes in the packet headers, the WLC 115 (or one of the APs 110 acting as the primary AP in the absence of a network controller) may identify the nature (or type) of the traffic flow and the likely applications involved. In some embodiments, in addition to or instead of examining the packet headers, Deep Packet Inspection (DPI) may be implemented to examine the payload of the packet. This approach allows for a more detailed analysis and application-level identification, such as recognizing traffic from a specific application based on the unique characteristics of the data within the packet.

In some embodiments, following the determination of the type of traffic each STA is managing and/or its associated application, the APs 110 or the WLC 115 may then consult defined QoS policies to determine the corresponding transmission requirements for each traffic flow. These requirements may include, but are not limited to, latency preferences, jitter sensitivity, queueing policy, the criticality to business operations (e.g., using labels like business-critical or business-relevant), latency and reliability needs, and the class of traffic (e.g., bulk data, etc.). Based on these requirements, the APs 110 or the WLC 115 may then prioritize the traffic flows within the network. The APs 110 or the WLC 115 may further instruct the STAs to adjust their network settings to align with the determined prioritization, thereby mitigating congestion and ensure optimized network performance even in high-density environments. For example, suppose the WLC 115 determines that the traffic flow between STA 105-1 and AP 105-1 is from a video conferencing application, the traffic flow between STA 105-2 and AP 110-2 is from a cloud-based application, and the traffic flow between STA 105-3 and AP 110-3 is from an online gaming app. Upon this identification, the WLC 115 consults predefined QoS policies to determine the transmission requirements for each type of traffic.

For example, the QoS policies may specify that traffic associated with video conferencing has high jitter sensitivity and high traffic criticality, whereas traffic related to a cloud-based application (involving file downloading/uploading) has lower jitter sensitivity and is less critical. In addition, traffic for online gaming or media streaming may be categorized as highly sensitive to jitter, but assigned low traffic criticality (especially in a corporate setting). Based on the identified QoS requirements, the WLC 115 may prioritize video conferencing traffic as high-priority due to its critical nature for business operations and sensitivity to jitter. In contrast, could-based services such as file downloading/uploading, having lower jitter sensitivity and traffic criticality, may be categorized as low-priority. Traffic related to online gaming or media streaming, which are tagged with low traffic criticality and high jitter sensitivity, may nevertheless be placed into the low-priority class.

Following these classifications, the WLC 115 may then direct respective STAs to modify their transmission settings. This may involve instructing STA 105-1, handling the high-priority video conferencing traffic, to increase its retry limits (e.g., to 32) and adopt a more aggressive strategy in selecting MCS indices. The instructions ensure that high-priority video conferencing traffic is transmitted reliably at fast speeds, even in congested network environments. In contrast, STAs 105-2 and 105-3, engaged in low-priority traffic, such as file downloading/uploading, online gaming, or media streaming, may be directed to reduce its retry limit (e.g., to 1) and use a more conservative strategy in MCS selection. The instructions help to speed up the decision to drop low-priority traffic if transmission fails, and therefore prevent unnecessary congestion in the network. The adaptive adjustment approach may optimize overall network efficiency in that it ensures that high-priority (or more important) applications (or network services) receive the necessary bandwidth and reliability, while low-priority (or less important) applications (or network services) are managed to prevent overloading the network.

In some embodiments, a single STA 105 may have multiple traffic flow, each with different QoS requirements or settings (e.g., streaming video, voice over IP (VoIP), web browsing) and categorized into various priority classes (e.g., high-priory class, low-priority class). In such configurations, the STA may apply different retry limits and MCS index selection strategies for each class of traffic it handles. The gradual control scheme allows for more efficient use of network resources, as it allows the STA to prioritize and optimize the transmission for each type of traffic based on its individual requirements and characteristics.

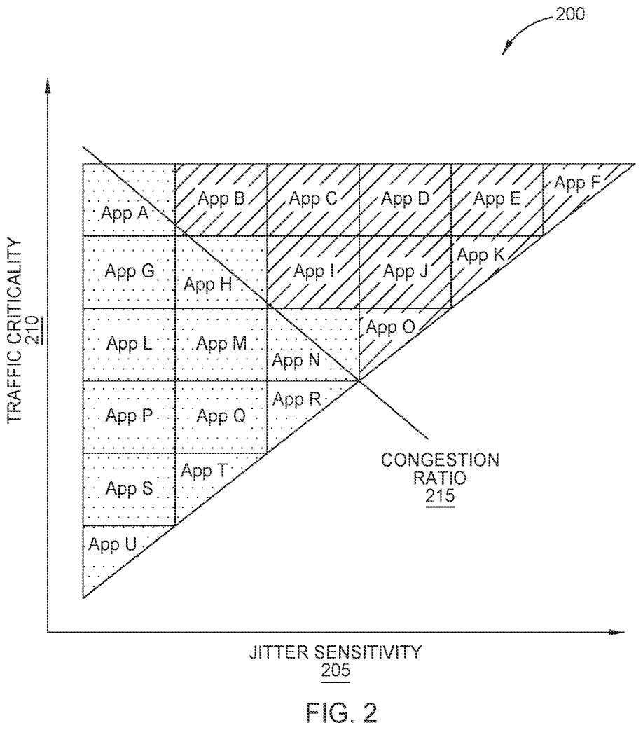

FIG. 2 depicts an example congestion ratio function 215 that categorizes available traffic flows into two priority classes, according to some embodiments of the present disclosure.

In the illustration, a coordinate system is presented, where the y-axis represents an application's traffic criticality 210, and the x-axis represents an application's jitter sensitivity 205. In some embodiments, the “traffic criticality” may be determined based on how important a network service (or traffic flow) is to the business or organization. For example, within a corporate setting, network policies may be established to categorize network services (or traffic flows) related to video conferencing as having higher criticality compared to services (or traffic flows) associated with general file downloading, web browsing, or media streamlining. In some embodiments, the x and y values that represent an application's jitter sensitivity and traffic criticality, respectively, may be determined based on predefined policies within the network. For example, a video conferencing application, which is typically highly sensitive to jitter and considered important for business operations, may be assigned a value of 10 for both traffic criticality and jitter sensitivity (on a scale of 0 to 10). These values may then be used to map the application into the coordinate system. As illustrated, blocks within the coordinate system represent 21 different applications, which are separated into two class, the high-priority class and the low-priority class, by the congestion ratio function 215. Applications within the high-priority category are indicated by blocks with hash patterns, while applications within the low-priority category are indicated by blocks with dot patterns In some embodiments, the congestion ratio function 215 may be represented or defined as y=−ax+b, where x represents the jitter sensitivity of an application, y represents the traffic criticality of the application, and a and b are coefficients that indicate the slope and intercept of the function.

The function 215 effectively separates the applications into two different classes within the coordinate system, based on their operational importance and network performance requirements. For example, Application U, characterized by low traffic criticality and low jitter sensitivity (such as a file downloading application), falls below the function line 215 and is thus categorized into the low-priority class. In contrast, Application F, with high traffic criticality and high jitter sensitivity (such as a video conferencing application), falls above the function line 215, placing it into the high-priority class. The congestion ratio function 215 and its coefficients (e.g., a and/or b) may be determined by a WLC (e.g., 115 of FIG. 1) or an AP (acting as the primary AP in the absence of a WLC) (e.g., 110-1 of FIG. 1) depending on defined network policies and detected congestion conditions. Various factors may be considered, including, but not limited to, the amount of data queued at each AP within the network (waiting for transmission) (also referred to in some embodiments as the current load on each AP), the amount of data queued at each STA (also referred to in some embodiments as the current load on each STA), and the count of retry bits in frames received from STAs over the last interval. In some embodiments, the WLC may learn a STA's current load through its buffer status report (BSR).

In some embodiments, the WLC or the primary AP may calculate the channel utilization (CU) for the network based on detected performance metrics (e.g., airtime usage). In some embodiments, CU may represent a percentage of time that the channel is actively being used for data transmission. When the CU is high, it represents that a significant portion of the channel's capacity is being used for data transmission. Therefore, a higher CU may indicate heavier traffic and potential congestion. In some embodiments, as CU increases, the congestion ratio function 215 may be adjusted to maintain network performance and effectively prioritize certain traffic. For example, in response to increased CU, the function 215 may be modified to categorize high-priority applications more strictly. This may involve increasing the coefficients a and/or b in the function 215 to ensure that only applications that are sufficiently business-critical and/or jitter-sensitive are classified as high-priority. The adjustments to function 215 helps in balancing network load, particularly in response to changing CU levels, while maintaining the quality of service for important (or high-priority) applications.

The coordinate system depicted is two-dimensional (e.g., based on traffic criticality and jitter sensitivity), provided primarily for conceptual clarity. In some embodiments, this coordinate system may be extended to include multiple dimensions that allow for a more comprehensive representation of various network parameters (e.g., three dimensions if latency preference is added into the coordinate system).

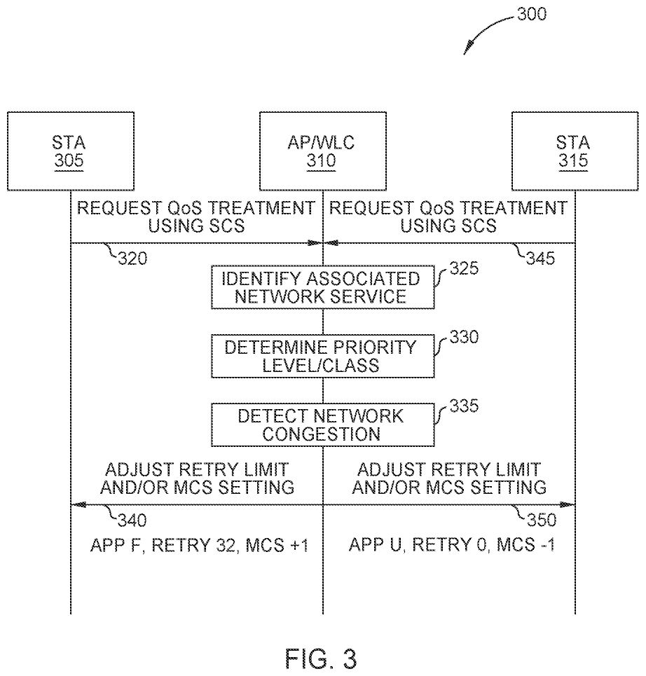

FIG. 3 depicts a sequence 300 by which an AP (or a WLC) evaluates and implements network adjustments for optimized traffic flow management, according to some embodiments of the present disclosure.

In the illustration, a sequence 300 is depicted, showing how the AP (or the WLC) 310 interacts with the STA 305 and STA 315 to identify the nature of their traffic and adjust network setting accordingly. The AP (or the WLC) 310 is associated with both STAs 305 and 315, and provides network access to both STAs.

As illustrated, each STA requests specific QoS treatment using the Stream Classification Service (SCS). The process involves embedding specific labels in the packets that are transmitted to the AP/WLC 310 (as depicted by arrows 320 and 345). In some embodiments, if the traffic flow from STA 305 originates from a video conferencing application, the packet header may include an Access Category (AC) label (or a high DSCP value) indicative of high priority, indicating the transmission requirements for low latency and high reliability. For example, the AC label for the Voice or Video category, or the DSCP value for expedited forwarding may be included within the header of the packets transmitted between STA 305 and AP/WLC 310. If the traffic flow from STA 315 is associated with a cloud-based application for file uploading and/or downloading, the packet header may include an AC label (or a low DSCP value) indicative of low priority. For example, the AC label for the Best Effort or Background category, or the DSCP value for bulk data transfer may be included within the header of the packets transmitted between STA 315 and AP/WLC 310.

In some embodiments, in addition to the AC category, the header of packets from each STA may further include additional attributes like the source and destination IP addresses, source and destination port numbers, and the protocol type (e.g., TCP or UDP). Based on these attributes and/or the AC category, the AP/WLC may determine the general nature (or type) of the traffic flow that each STA is managing (e.g., video, voice, data transfer) as well as the likely applications or network services involved (as depicted by block 325). In some embodiments, for more granular and accurate identification, the AP/WLC 310 may perform DPI to identify the specific applications associated with each traffic flow. The DPI involves examining the payload of the packets, which allows the AP/WLC 310 to detect unique patterns or signatures corresponding to specific applications. For example, the AP/WLC, through DPI, may identify that the video conferencing traffic from STA 305 is related to a specific video conferencing provider, and the file downloading traffic from STA 315 is for a specific cloud-based storage provider.

Following the identification of either the general nature (or type) of the traffic flow (e.g., video, voice, data transfer) or the specific applications associated with each traffic flow (e.g., specific service providers), the AP/WLC 310 consults the established QoS policies to determine the transmission requirements defined for each type of traffic or for a particular application. These requirements may include latency needs (e.g., high or low latency), reliability (e.g., high or standard reliability), jitter sensitivity (e.g., high or low sensitivity), and traffic criticality (e.g., high, medium, or low criticality). For example, the policies may define that video conferencing applications (like Webex™) involving real-time communication require low latency and are highly sensitive to jitter. In a corporate setting, these applications may be classified by the policies as highly critical to business operations. In contrast, the policies may define file downloading or uploading applications as having less stringent latency requirements and less sensitivity to jitter, and assign these applications to a medium or low traffic criticality. In addition, for applications designed for entertainment, such as online gaming or video streaming, policies may acknowledge the requirements for low latency and high sensitivity to jitter due to their real-time interaction nature. However, in a corporate setting, these applications may be assigned a low traffic criticality, indicating their lower importance in business operations.

In some embodiments, the policies may utilize a numerical scale to quantify the extent of jitter sensitivity or traffic criticality for each type of traffic flow or a specific application. For example, a scale from 0 to 10 may be used to represent the level of jitter sensitivity, where applications for video conferencing may be assigned a high value like 10 (indicating their high sensitivity to jitter), while applications for file downloading may be assigned a lower value, such as 2 or 3 (suggesting their low jitter sensitivity). Similarly, a similar scale from 0 to 10 may be used to represent the level of traffic criticality for each application or network service. On this scale, applications integral to business operations, such as video conferencing applications, may be rated near 10, while applications used for non-critical functions, like entertainment video streaming or web browsing in a corporate environment, may be assigned lower values, such as 1 or 2.

The aforementioned example that describes a scale from 0 to 10 for jitter sensitivity or traffic criticality is provided for conceptual clarity. The numerical scale may change depending on specific network environment. Additionally, in some embodiments, the traffic criticality assigned to different applications may vary depending on the environment in which the network is utilized. For example, in a residential setting, applications for personal media streaming may be assigned a higher traffic criticality value, indicating their greater importance in that context, while the criticality of applications like video conferencing may be lowered. These value assignments are flexible and can be adjusted by the organizations or network administrators based on their unique needs and the specific operational environment of the network.

In the illustration, after the determination of the associated network service or application for each traffic flow, the AP/WLC 310 prioritizes these traffic flows (e.g., from STA 305 and 315) based on their respective police-defined requirements (as depicted by block 330). In embodiments where quantified values for jitter sensitivity and/or traffic criticality are assigned to each application (and their respective traffic flows), the AP/WLC 310 may aggregate these values to calculate a priority value, ranking the traffic flows from highest to lowest priority. A higher priority value indicates a greater need for stable and/or fast network service. In some embodiments, each application may be mapped into a coordinate system (as depicted by FIG. 2) based on its assigned values for jitter sensitivity and/or traffic criticality. A congestion ratio function (e.g., 215 of FIG. 2) may then be applied to categorize these applications into two categories: high-priority category and low-priority category.

As illustrated, the AP/WLC 310 continuously or periodically monitors network performance for signs of congestion. In some embodiments, congestion may occur when data queued at the AP and STAs exceeds the available timeslots for transmission. In some embodiments, congestion may be indicated by the CU exceeding a defined threshold. Upon detecting congestion, the AP/WLC 310 switches to a congestion management mode (specifically designed to manage congestion). In this mode, the AP/WLC 310 directs STAs 305 and 315 to adjust their transmission settings based on their priority values or classes (as depicted by arrows 340 and 345). For example, if the video conferencing traffic from STA 305 (associated with application F) is classified into a high-priority class, the AP/WLC 310 may send instructions to STA 305 to increase its retry limit (e.g., to 32), and to adopt a more aggressive MCS selection strategy (as indicated by the aggressiveness factor (+1)) than following the standard selection rules. The more aggressive MCS selection strategy prioritizes data rate over reliability. Upon receiving the instructions 340, the STA 305 may select a MCS index that offers a higher data speed available within its capacities than the MCS index selected following the standard selection rules. For example, under the standard rules, STA 305 may select MCS index 5, which offers a balanced trade-off between data rate and reliability. However, with the AP's instructions 340 to prioritize data rate, STA 305 may opt for MCS index 7 or 8 (assuming it is within the STA 305's range of capacity). The higher MCS index offers faster data rates, which are beneficial for the real-time requirements of video conferencing, even though it may be less robust in terms of error correction compared to a lower index. However, the disadvantage in robustness is compensated by the increased retry limit, which allows more retransmission in cases of packet loss. Therefore, the instructions 340 may enable the STA 305 to maintain the overall reliability of the high-priority video conferencing traffic with increased data transfer rates.

For the file downloading traffic flow from STA 315 (associated with application U) classified into a low-priority class, the AP/WLC 310 may send instructions 350 to STA 315 to reduce its retry limit (e.g., to 0), and to adopt a more conservative MCS selection strategy (as indicated by the aggressiveness factor (−1)) compared to the standard rules. The more conservative MCS selection strategy emphasizes reliability over data rate, focusing on stable transmission even at slower speeds. The instructions 350 direct the STA 315 to select a MCS index that offers more robust transmissions within its capacities (e.g., the index that is less likely to require retransmissions) that the MCS index selected following the standard selection rules, even if it does not provide the highest possible data rate. For example, under the standard rules, STA 315 may select MCS index 6. However, with the AP's instructions 350 to prioritize network reliability in a congested network, STA 315 may shift to MCS index 3 or 4. These lower indices are more robust against errors and are less likely to require retransmissions, which compensate for the disadvantage caused by the reduced retry limit. The instructions 350 may help to reduce network congestion by ensuring that low-priority traffic uses less bandwidth and is less aggressive in terms of retransmissions. Such adjustments may free up network resources for high-priority applications, and therefore improve the overall network performance.

In some embodiments, the instructions 340 and 350 for adjusting network settings may be communicated by AP/WLC 310 to STAs 305 and 315 through a QoS policy update or an SCS counter proposal.

In some embodiments, the retry limits for each STA may be fine-tuned based on the priority value calculated for each traffic flow it is handling. In some embodiments, the aggressiveness factor like (−1), (+1), and 0 are used to indicate the direction of MCS threshold adjustment, where (+1) indicates the MCS selection should be more aggressive compared to the standard rules (e.g., selecting MCS index 7 when standard rules suggest MCS index 6), 0 suggests following the standard rules for selecting the MCS index (e.g., selecting MCS index 6), and (−1) represents the MCS selection should be more conservative compared to the standard rules (e.g., selecting MCS index 5 when standard rules suggest MCS index 6). In some embodiments, in addition to or instead of using the Boolean values like (−1), 0, or (+1), the AP/WLC 310 may specify a down-shifting factor in its instructions 340 and 350. For example, an instruction like “2 MCS down” suggests reducing the MCS level by two steps from its standard or current selection. Assuming that the STA 315 selects MCS index 5 under the standard rules, but receives the instruction of “2 MCS down” due to its low priority, the STA 315 may adjust to select MCS index 3. The down-shifting adjustments may allow the STA 315 to trade off high data rates for a greater chance of successful transmission on the first attempt.

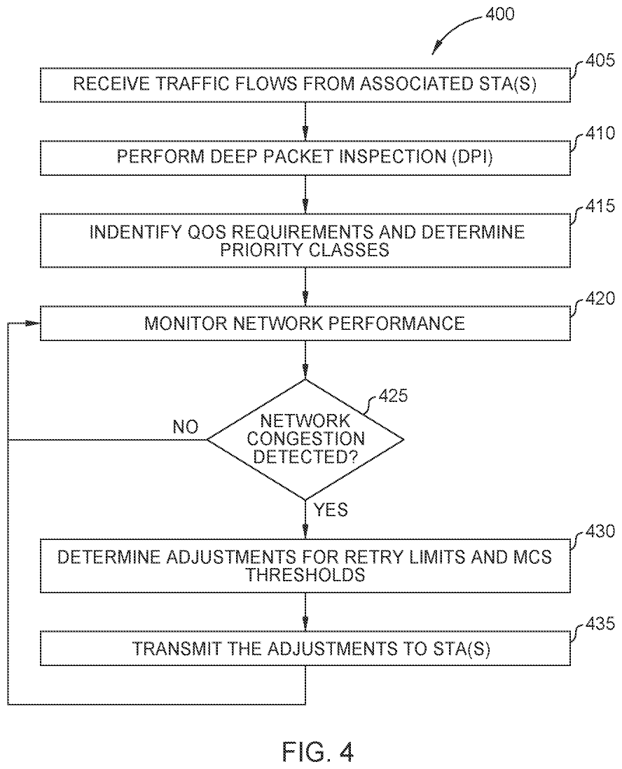

FIG. 4 depicts an example method 400 for assessing network conditions and assigning corresponding QoS parameters for effective data transmission, according to some embodiments of the present disclosure. In some embodiments, the method 400 may be performed by an AP, such as the APs 110 of FIG. 1, and the AP 310 of FIG. 3, and/or a WLC, such as the WLC 115 of FIG. 1.

At block 405, an AP (or a WLC) receives traffic flows from its associated STAs (e.g., STAs 105 of FIG. 1, STAs 305 and 315 of FIG. 3). Each traffic flow consists of data packets, and the header of the packets include information about the nature or type of traffic each STA is handling, such as the Access Category (AC) (or the DSCP value), the source and destination IP addresses, port numbers, and protocol types.

At block 410, the AP (or the WLC) analyzes the header information to determine the type of traffic (e.g., video, voice, data transfer) and the possible applications involved for each traffic flow. In some embodiments, DPI may be performed by the AP to examine the payload of these packets for a more detailed and accurate identification of the application. Through DPI, the AP (or the WLC) may identify the specific applications associated with each traffic flow (also referred to in some embodiments as application-level identification).

At block 415, the AP (or the WLC), based on the determined traffic type or involved applications, identifies the QoS requirements for each traffic flow, considering factors like latency needs, reliability, jitter sensitivity, and traffic criticality, among others. In some embodiments, the QoS requirements for each type of traffic or a specific application are predefined in network polices by the organizations (or network administrators) based on their unique needs and the specific operational environment of the network (e.g., a corporate setting or a residential setting). Using the information, the AP (or the WLC) may determine the priority class or priority value for each traffic flow. For example, in embodiments where quantified values for jitter sensitivity and traffic criticality are assigned for each application, these applications may be mapped into a coordinate system (e.g., 200 of FIG. 2), where the x-axis represents jitter sensitivity and the y-axis represents traffic criticality. A congestion ratio function (e.g., 215 of FIG. 2) may then be applied to separate these applications into two classes: the high-priory and low-priority classes. In some embodiments, the AP may calculate a priority value for each application by aggregating their respective assigned values for jitter sensitivity and/or traffic criticality (defined in QoS policies). The AP may then prioritize the applications and their associated traffic flows based on the aggregated values.

At block 420, the AP (or the WLC) monitors the network performance for signs of congestion. This may involve evaluating metrics such as CU and other relevant indicators to gauge the overall network condition.

At block 425, the AP (or the WLC) evaluates whether network congestion is detected. If congestion is detected, as indicated by metrics like CU exceeding a defined threshold, the method 400 proceeds to block 430. If no congestion is detected, indicated by metrics like CU falling under the defined threshold, the method 400 returns to block 420, where the AP (or the WLC) continues to monitor network performance

At block 430, in response to congestion, the AP (or the WLC) determines adjustments for the retry limits and MCS threshold for each associated STA. The adjustments may include, for example, increasing retry limits and specifying a more aggressive MCS selection strategy for high-priority traffic, and reducing retry limits and specifying a more conservative MCS selection strategy for low-priority traffic.

At block 435, the AP (or the WLC) transmits the adjustments to the STAs (e.g., STAs 105 of FIG. 1, STAs 305 and 315 of FIG. 3). The instructions specify the new retry limits, retry selection strategies (e.g., to be more or less aggressive for retries), the new MCS settings, and/or the MCS selection strategies (e.g., indicated by an aggressiveness factor or a down-shifting factor) for each traffic flow managed by the STAs. Upon receiving the instructions, each STA may adapt the transmission settings for each type of traffic flow (e.g., streaming video, voice over IP (VOIP), web browsing), aligning these settings with the respective priority class (e.g., high-priority class, low-priority class) of the traffic. After implementing the adjustments, the AP (or the WLC) continues to monitor the network performance to assess the effectiveness of these changes.

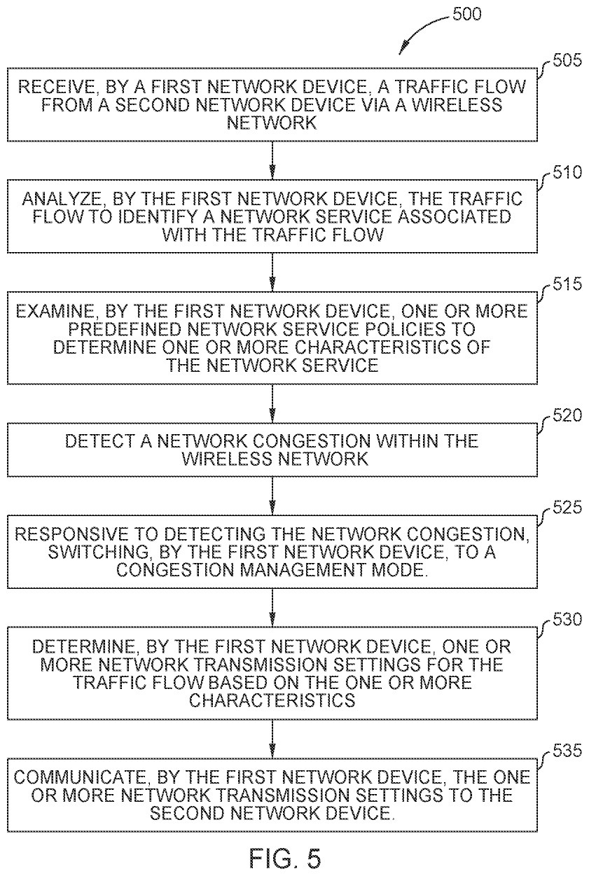

FIG. 5 is a flow diagram depicting an example method 500 for adaptively adjusting network transmission settings based on the QoS requirements of different traffic flows, according to some embodiments of the present disclosure.

At block 505, a first network device (e.g., the APs 110 of FIG. 1, the WLC 115 of FIG. 1, the AP/WLC 310 of FIG. 3) receives a traffic flow from a second network device (e.g., the STAs 105 of FIG. 1, the STAs 305 and 315 of FIG. 3) via a wireless network. In some embodiments, the first network device may comprise an access point (AP) or a wireless controller (WLC). In some embodiments, the second network device may comprise a station (STA) associated with the first network device for network connection.

At block 510, the first network device analyzes the traffic flow to identify a network service associated with the traffic flow (as depicted by block 325 of FIG. 3).

At block 515, the first network device examines one or more defined network service policies to determine one or more characteristics of the network service (as depicted by block 330 of FIG. 3). In some embodiments, the one or more characteristics of the network service may comprise at least one of (i) a differentiated service code point (DSCP) value, (ii) a category of traffic, (iii) a traffic criticality level, (iv) a latency preference, (v) a reliability preference, (v) a jitter sensitivity level, or (vi) a queueing policy, defined for the network service.

At block 520, the first network device detects a network congestion within the wireless network (as depicted by block 335 of FIG. 3). In some embodiments, detecting a network congestion within the wireless network may further comprise detecting that a channel utilization ratio of the wireless network exceeds a defined threshold.

At block 525, responsive to detecting the network congestion, the first network device switches to a congestion management mode, further comprising: determining, by the first network device, adjustments for one or more network transmission settings for the traffic flow based on the one or more characteristics, and communicating, by the first network device, the adjustments to the second network device (as depicted by arrows 340 and 350 of FIG. 3). In some embodiments, the one or more network transmission settings may comprise at least one of (i) a packet retry value, (ii) an aggressiveness factor for Modulation and Coding Scheme (MCS) selection, or (iii) a down-shifting factor for MCS selection.

In some embodiments, the first network device may further calculate a priority value for the network service, based on the one or more characteristics of the network service, and determine the adjustments for the one or more network transmission settings for the traffic flow based on the priority value.

In some embodiments, the first network device may further compute a congestion ratio function (e.g., 215 of FIG. 2) based on congestion conditions of the network, determine a priority class of the network service, using the congestion ratio function, based on the one or more characteristics, and determine the adjustments for the one or more network transmission settings for the traffic flow based on the priority class.

In some embodiments, the congestion conditions of the network may comprise at least one of (i) a number of active connections of the first network device; (ii) an amount of data waiting at the first network device; (iii) an amount of data waiting at the second network device; or (iv) an amount of retry bits received by the first network device over an interval.

In some embodiments, the congestion ratio function may be defined to categorize the network service into either a low-priority class or a high-priority class. In some embodiments, the congestion ratio function may be a linear function of a traffic criticality level and a jitter sensitivity level, adjusted by one or more coefficients.

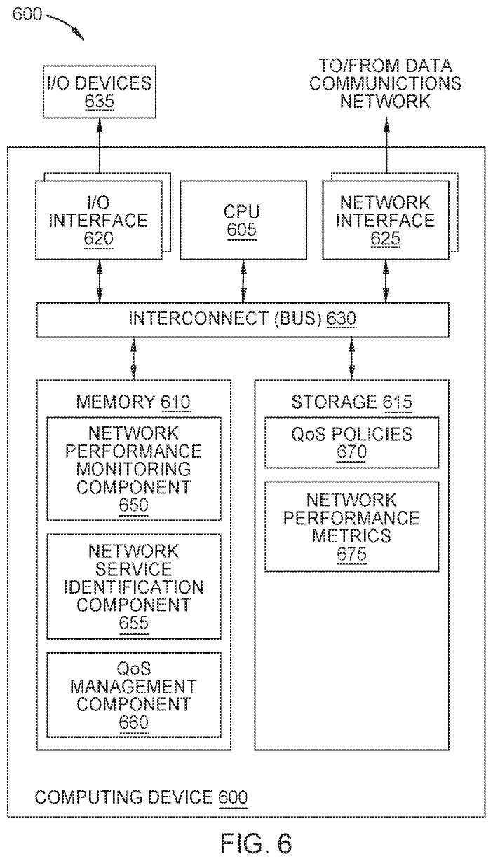

FIG. 6 depicts an example computing device 600 configured to perform various aspects of the present disclosure, according to one embodiment. Although depicted as a physical device, in embodiments, the computing device 600 may be implemented using virtual device(s), and/or across a number of devices (e.g., in a cloud environment). In one embodiment, the computing device 600 may correspond to an AP, such as the APs 110 of FIG. 1, or the AP 310 of FIG. 3. In one embodiment, the computing device 600 may correspond to a WLC, such as the WLC 115 of FIG. 1.

As illustrated, the computing device 600 includes a CPU 605, memory 610, storage 615, one or more network interfaces 625, and one or more I/O interfaces 620. In the illustrated computing device, the CPU 605 retrieves and executes programming instructions stored in memory 610, as well as stores and retrieves application data residing in storage 615. The CPU 605 is generally representative of a single CPU and/or GPU, multiple CPUs and/or GPUs, a single CPU and/or GPU having multiple processing cores, and the like. The memory 610 is generally included to be representative of a random access memory. Storage 615 may be any combination of disk drives, flash-based storage devices, and the like, and may include fixed and/or removable storage devices, such as fixed disk drives, removable memory cards, caches, optical storage, network attached storage (NAS), or storage area networks (SAN).

In some embodiments, I/O devices 635 are connected via the I/O interface(s) 620. Further, via the network interface 625, the computing device 600 can be communicatively coupled with one or more other devices and components (e.g., via a network, which may include the Internet, local network(s), and the like). As illustrated, the CPU 605, memory 610, storage 615, network interface(s) 625, and I/O interface(s) 620 are communicatively coupled by one or more buses 630. In some embodiments, the computing device 600 may include one or more antennas and one or more RF transceivers. In some embodiments, the computing device 600 may include transmit (TX) processing circuitry and receive (RX) processing circuitry for handling the transmission of data between the device 600 and its connected client devices (or STAs).

In the illustrated computing device, the memory 610 includes a network performance monitoring component 650, a network service identification component 655, and a QoS management component 660. Although depicted as a discrete component for conceptual clarity, in some aspects, the operations of the depicted component (and others not illustrated) may be combined or distributed across any number of components. Further, although depicted as software residing in memory 610, in some aspects, the operations of the depicted components (and others not illustrated) may be implemented using hardware, software, or a combination of hardware and software.

In one embodiment, the network performance monitoring component 650 may monitor the network performance in real time. The component 650 may track various metrics such as bandwidth usage, latency, packet loss, signal strengths (e.g., received signal strength indicator (RSSI), signal-to-noise ratio (SNR)), and error rates. By analyzing the collected data, the component 650 may identify trends and patterns within the network, such as traffic being unusually high or increasing rapidly, to identify potential congestion. In some embodiments, the component 650 may calculate CU based on the collected data. In some embodiments, the component 650 may set and monitor thresholds for various performance metrics. If metrics like CU, latency, or packet loss exceed these thresholds, indicating network congestion, the network performance monitoring component 650 may alert the QoS management component 660. The alert may prompt the QoS management component 660 to switch to a congestion management mode. Under this mode, the QoS component 660 makes adaptive adjustments to network settings based on the current network conditions and the priority classes of the traffic flows. In some embodiments, the adjustments may include changes to retry limits and MCS selection.

In one embodiment, the network service identification component 655 may analyze the content of data packets transmitted within the network, including headers and/or payloads, to identify the applications or network services generating the traffic. Packet headers may include information such as source and destination IP addresses, port numbers, and protocol types. Based on this information, the component 655 may identify the general nature of the traffic (e.g., categorizing it into types like voice, video, data transfer, or other specific services), and/or infer the possible associated application. In some embodiments, to achieve a more precise identification, the component 655 may implement DPI to examine the payload of a packet, and identify patterns, data formats, or signatures that are uniquely associated with specific applications. By examining the payload, the component 655 may distinguish traffic from various applications or network services and, in some embodiments, determine the specific name of each application. The identified information may then be provided to the QoS management component 660 for more precise network management and policy enforcement.

In one embodiment, based on the information provided by the network service identification component 655 (like the type of traffic or the specific application name), the QoS management component 660 may check defined policies to identify transmission requirements related to a specific type of traffic or an application. For example, the policy may specify that traffic for video conferencing applications requires low latency, is sensitive to jitter, and is highly critical to business operations in corporate settings. For traffic for file downloading or web browsing applications, the policy may define it as having less stringent latency requirements, lower sensitivity to jitter, and assigning the traffic to a medium or low traffic criticality. Based on the different transmission requirements, the QoS management component 660 may categorize traffic flows into different priority classes, such as a high-priority class for critical, jitter-sensitive traffic like video conferencing, and a low-priority class for less critical, less jitter-sensitive traffic like file downloading or web browsing. When the network performance monitoring component 650 alerts that potential congestion is detected, the QoS management component 660 may respond by adjusting the network settings of a STA according to the priority class of the traffic flow it is handling. For STAs managing high-priority traffic flows, the QoS management component 660 may direct them to increase retry limits, and select MCS indices that prioritize data rate over reliability. For STAs handling low-priority traffic flows, the QoS management component 660 may instruct them to lower their retry limits, and select MCS indices that are more conservative (prioritizing reliability over data rate). The QoS management component 660 may transmit the adjustments to STAs through QoS policy updates or SCS counter proposals.

In the illustrated example, the storage 615 includes the defined QoS policies 670 (including transmission rules for different types of traffic) and data related to network traffic 675 (such as bandwidth usage, signal strengths, error rates, and CU). Although depicted as residing in storage 615, the aforementioned data may be stored in any suitable location, such as a remote database.

In the current disclosure, reference is made to various embodiments. However, the scope of the present disclosure is not limited to specific described embodiments. Instead, any combination of the described features and elements, whether related to different embodiments or not, is contemplated to implement and practice contemplated embodiments. Additionally, when elements of the embodiments are described in the form of “at least one of A and B,” or “at least one of A or B,” it will be understood that embodiments including element A exclusively, including element B exclusively, and including element A and B are each contemplated. Furthermore, although some embodiments disclosed herein may achieve advantages over other possible solutions or over the prior art, whether or not a particular advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, the embodiments disclosed herein may be embodied as a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer readable medium(s) having computer readable program code embodied thereon.

Program code embodied on a computer readable medium may be transmitted using any appropriate medium, including but not limited to wireless, wireline, optical fiber cable, RF, etc., or any suitable combination of the foregoing.

Computer program code for carrying out operations for embodiments of the present disclosure may be written in any combination of one or more programming languages, including an object oriented programming language such as Java, Smalltalk, C++or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations and/or block diagrams of methods, apparatuses (systems), and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block(s) of the flowchart illustrations and/or block diagrams.

These computer program instructions may also be stored in a computer readable medium that can direct a computer, other programmable data processing apparatus, or other device to function in a particular manner, such that the instructions stored in the computer readable medium produce an article of manufacture including instructions which implement the function/act specified in the block(s) of the flowchart illustrations and/or block diagrams.

The computer program instructions may also be loaded onto a computer, other programmable data processing apparatus, or other device to cause a series of operational steps to be performed on the computer, other programmable apparatus or other device to produce a computer implemented process such that the instructions which execute on the computer, other programmable data processing apparatus, or other device provide processes for implementing the functions/acts specified in the block(s) of the flowchart illustrations and/or block diagrams.

The flowchart illustrations and block diagrams in the Figures illustrate the architecture, functionality, and operation of possible implementations of systems, methods, and computer program products according to various embodiments. In this regard, each block in the flowchart illustrations or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

In view of the foregoing, the scope of the present disclosure is determined by the claims that follow.

We claim:

1. A method comprising:
receiving, by a first network device, a traffic flow from a second network device via a wireless network;
analyzing, by the first network device, the traffic flow to identify a network service associated with the traffic flow;
examining, by the first network device, a defined network service policy to determine one or more characteristics of the network service;
detecting, by the first network device, a network congestion within the wireless network; and
responsive to detecting the network congestion, switching, by the first network device, to a congestion management mode, further comprising:
determining, by the first network device, adjustments for one or more network transmission settings for the traffic flow based on the one or more characteristics, and
communicating, by the first network device, the adjustments to the second network device.

2. The method of claim 1, wherein the first network device comprises an access point (AP) or a wireless controller (WLC).

3. The method of claim 1, wherein the second network device comprises a station (STA) associated with the first network device for network connection.

4. The method of claim 1, wherein the one or more characteristics of the network service comprise at least one of (i) a differentiated service code point (DSCP) value, (ii) a category of traffic, (iii) a traffic criticality level, (iv) a latency preference, (v) a reliability preference, (v) a jitter sensitivity level, or (vi) a queueing policy, defined for the network service.

5. The method of claim 1, wherein the one or more network transmission settings comprise at least one of (i) a packet retry value, (ii) an aggressiveness factor for Modulation and Coding Scheme (MCS) selection, or (iii) a down-shifting factor for MCS selection.

6. The method of claim 1, further comprising:
calculating a priority value for the network service, based on the one or more characteristics of the network service; and
determining, by the first network device, the adjustments for the one or more network transmission settings for the traffic flow based on the priority value.

7. The method of claim 1, further comprising:
computing a congestion ratio function based on congestion conditions of the network;
determining a priority class of the network service, using the congestion ratio function, based on the one or more characteristics; and
determining, by the first network device, the adjustments for the one or more network transmission settings for the traffic flow based on the priority class.

8. The method of claim 7, wherein the congestion conditions of the network comprises at least one of (i) a number of active connections of the first network device; (ii) an amount of data waiting at the first network device; (iii) an amount of data waiting at the second network device; or (iv) an amount of retry bits received by the first network device over an interval.

9. The method of claim 7, wherein the congestion ratio function is defined to categorize the network service into either a low-priority class or a high-priority class.

10. The method of claim 7, wherein the congestion ratio function is a linear function of a traffic criticality level and a jitter sensitivity level, adjusted by one or more coefficients.

11. The method of claim 1, wherein detecting a network congestion within the wireless network further comprises detecting that a channel utilization ratio of the wireless network exceeds a defined threshold.

12. A system comprising:
one or more computer processors; and
one or more memories collectively containing one or more programs, which, when executed by the one or more computer processors, perform operations, the operations comprising:
receiving, by a first network device, a traffic flow from a second network device via a wireless network;
analyzing, by the first network device, the traffic flow to identify a network service associated with the traffic flow;
examining, by the first network device, a defined network service policy to determine one or more characteristics of the network service;
detecting, by the first network device, a network congestion within the wireless network; and
responsive to detecting the network congestion, switching, by the first network device, to a congestion management mode, further comprising:
determining, by the first network device, adjustments for one or more network transmission settings for the traffic flow based on the one or more characteristics, and
communicating, by the first network device, the adjustments to the second network device.

13. The system of claim 12, wherein the first network device comprises an access point (AP) or a wireless controller (WLC).

14. The system of claim 12, wherein the second network device comprises a station (STA) associated with the first network device for network connection.

15. The system of claim 12, wherein the one or more characteristics of the network service comprise at least one of (i) a differentiated service code point (DSCP) value, (ii) a category of traffic, (iii) a traffic criticality level, (iv) a latency preference, (v) a reliability preference, (v) a jitter sensitivity level, or (vi) a queueing policy, defined for the network service.

16. The system of claim 12, wherein the one or more network transmission settings comprise at least one of (i) a packet retry value, (ii) an aggressiveness factor for Modulation and Coding Scheme (MCS) selection, or (iii) a down-shifting factor for MCS selection.

17. The system of claim 12, wherein the one or more programs, which, when executed on any combination of the one or more computer processors, performs the operations further comprising:
calculating a priority value for the network service, based on the one or more characteristics of the network service; and
determining, by the first network device, the adjustments for the one or more network transmission settings for the traffic flow based on the priority value.

18. The system of claim 12, wherein the one or more programs, which, when executed on any combination of the one or more computer processors, performs the operations further comprising:
computing a congestion ratio function based on congestion conditions of the network;
determining a priority class of the network service, using the congestion ratio function, based on the one or more characteristics; and
determining, by the first network device, the adjustments for the one or more network transmission settings for the traffic flow based on the priority class.

19. The system of claim 18, wherein the congestion ratio function is defined to categorize the network service into either a low-priority class or a high-priority class.

20. One or more non-transitory computer-readable media containing, in any combination, computer program code that, when executed by a computer system, performs operations comprising:
receiving, by a first network device, a traffic flow from a second network device via a wireless network;
analyzing, by the first network device, the traffic flow to identify a network service associated with the traffic flow;
examining, by the first network device, a defined network service policy to determine one or more characteristics of the network service;
detecting, by the first network device, a network congestion within the wireless network; and
responsive to detecting the network congestion, switching, by the first network device, to a congestion management mode, further comprising:
determining, by the first network device, adjustments for one or more network transmission settings for the traffic flow based on the one or more characteristics, and
communicating, by the first network device, the adjustments to the second network device.
